(19) United States
(12) Patent Application Publication
(10) Pub. No.: US 2023/0196278 A1
(43) Pub. Date: Jun. 22, 2023

(54) NETWORK INVENTORY REPLENISHMENT PLANNER

(71) Applicant: International Business Machines Corporation, Armonk, NY (US)

(72) Inventors: Pavithra Harsha, Pleasantville, NY (US); Brian Leo Quanz, Yorktown Heights, NY (US); Ali Koc, White Plains, NY (US); Dhruv Shah, New York, NY (US); Shivaram Subramanian, Frisco, TX (US); Ajay Ashok Deshpande, Pleasantville, NY (US); Chandrasekhar Narayanaswami, Wilton, CT (US)

(21) Appl. No.: 17/553,195

(22) Filed: Dec. 16, 2021

(51) Int. Cl. G06Q 10/08; G06Q 10/06; G06Q 30/02

(52) U.S. Cl. CPC G06Q 10/087; G06Q 10/06393; G06Q 30/0202

(57) ABSTRACT

A processor in an omnichannel environment, over a specific network with transaction level operations, may receive one or more input configurations. The processor may identify, based on the one or more input configurations, one or more articles. The processor may identify one or more key performance indicators (KPIs) associated with the one or more articles. The processor may compute, based on an uncensored demand trajectory, an impact on the KPIs over a specified period in the omnichannel environment. The processor may provide the impact to a user.

### BACKGROUND

The present disclosure relates generally to the field of supply chain, and more specifically to inventory replenishment planning.

Firms extensively use complex fulfillment strategies (e.g., SFS, BOPUS, etc.) to better utilize inventory while minimizing fulfillment costs. However, omnichannel supply chains are riddled with problems such as lower margins due to excessive fulfillment costs, stock-outs, markdowns, and returns. Suppose a firm alters the method or optimizes the way they are replenishing inventory (e.g., ordering from supplier and\or positioning the purchased inventory within a network) in a retail network different by for example, moving away from siloed single channel or single location replenishment.

### SUMMARY

Embodiments of the present disclosure include a method, computer program product, and system for inventory replenishment planning. A processor in an omnichannel environment, over a specific network with transaction level operations, may receive one or more input configurations. The processor may identify, based on the one or more input configurations, one or more articles. The processor may identify one or more key performance indicators (KPIs) associated with the one or more articles. The processor may compute, based on an uncensored demand trajectory, an impact on the KPIs over a specified period in the omnichannel environment. The processor may provide the impact to a user.

In some embodiments, providing the impact to the user may include the processor generating a demand forecast used for replenishment of specific inventory. The specific inventory may be associated with the one or more articles.

In some embodiments, generating the demand forecast used for replenishment of the specific inventory may include the processor analyzing a fulfillment segment at a granular level (SKU-location-fulfillment segment level) and an aggregated level. The processor may further generate an uncertain forecast at the granular level as the demand forecast. The uncertain forecast may include a full distribution or prediction intervals that may be used for replenishment.

In some embodiments, the processor may optimize replenishment, where optimizing replenishment may include the processor identifying one or more rules from a controlling entity and consuming an output of the demand forecast.

In some embodiments, the processor may utilize virtual sales estimates (lost sales estimates imputed in the historical data) during the specified period.

In some embodiments, the processor may update inventory with incoming reloads. The processor may update inventory with walk-in point of sale data. The processor may process Ecommerce sales orders. The processor may update the inventory with virtual walk-in point of sale data. The processor may process Ecommerce return orders. The processor may replenish, periodically, the inventory.

In some embodiments, the processor may synchronize, automatically, one or more pluggable components in the omnichannel environment as based on the one or more input configurations.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A illustrates a block diagram of an example system for inventory replenishment planning, in accordance with aspects of the present disclosure.

FIG. 1B illustrates a flowchart of example processes for a planner of inventory replenishment planning, in accordance with aspects of the present disclosure.

FIG. 1C illustrates a block diagram of an example pre-processing system for inventory replenishment planning, in accordance with aspects of the present disclosure.

FIG. 2 illustrates a flowchart of an example method for inventory replenishment planning, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of supply chain, and more specifically to inventory replenishment planning. While the present disclosure is not necessarily limited to such applications, various aspects of the disclosure may be appreciated through a discussion of various examples using this context.

Firms extensively use complex fulfillment strategies (e.g., ship-from-store [SF'S] buy online, pickup in store [BOPUS], etc.) to better utilize inventory while minimizing fulfillment costs. Yet omnichannel supply chains are riddled with problems such as lower margins due to excessive fulfillment costs, stock-outs, markdowns and returns.

Suppose that a firm alters the method or re-optimizes the way they are replenishing inventory (e.g., ordering from supplier and\or positioning the purchased inventory within a network) in a retail network, different by, for example, moving away from siloed single channel or single location replenishment, how do they evaluate the impact on the KPIs due to this change? This disclosure describes how they can accurately evaluate the impact on KPIs in an omnichannel environment due to this change/optimization. Disclosed herein is a what-if simulator/system for firms to simulate various combinations of forecasting and replenishment strategies, and estimate the business (e.g., KPI) impact of the end-to-end replenishment solution. The disclosed simulator discussed throughout this disclosure, may compare the firm's as-is business process and/or alternative solutions, and identify/output the best overall combination; this is done in an automated manner.

For example, a retailer may use a single designated warehouse to replenish each store's inventory in their network. They may be considering a different network configuration—in particular they may want to consider allowing all warehouses to replenish all stores, or allowing each store to have designated more than 1 warehouse to replenish it, or even allowing specific stores to replenish specific other stores. There are many possible configurations they may want to try and experiment with, and many possible ways of deciding on and executing the replenishment, but they need some way to evaluate what impact these will have on the KPIs they care about. There are also various other settings and configurations that can be evaluated, such as the amount of inventory for different SKUs (articles, products, etc.) to initialize each node (e.g., warehouse, distribution center, store, etc.) in the network at the start of a season (e.g., specific period).

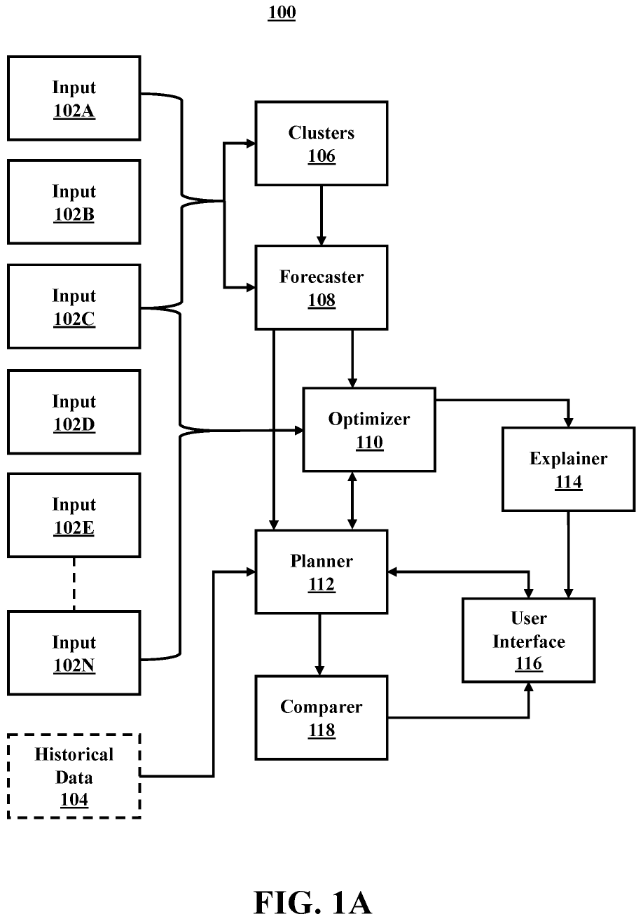

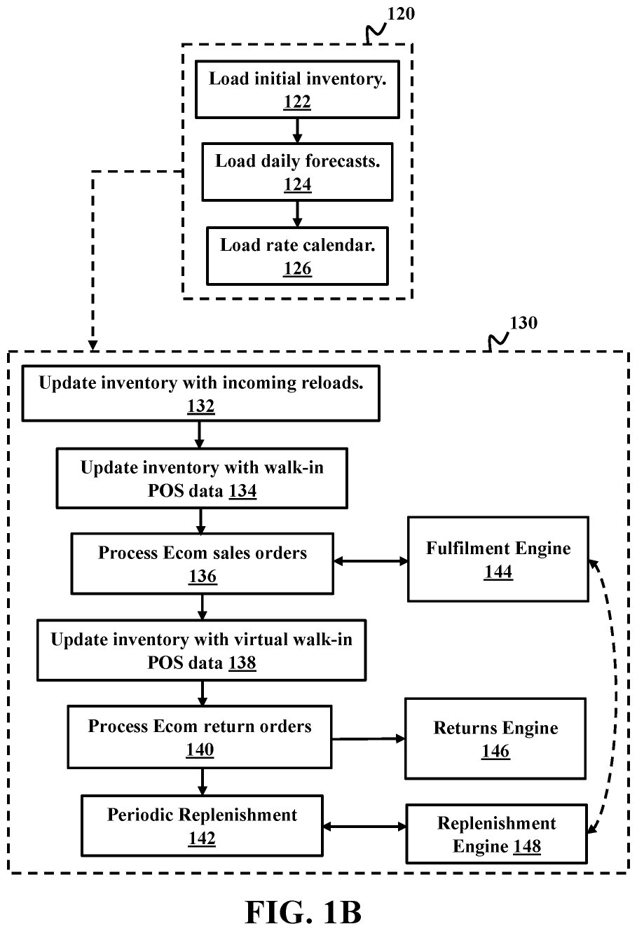

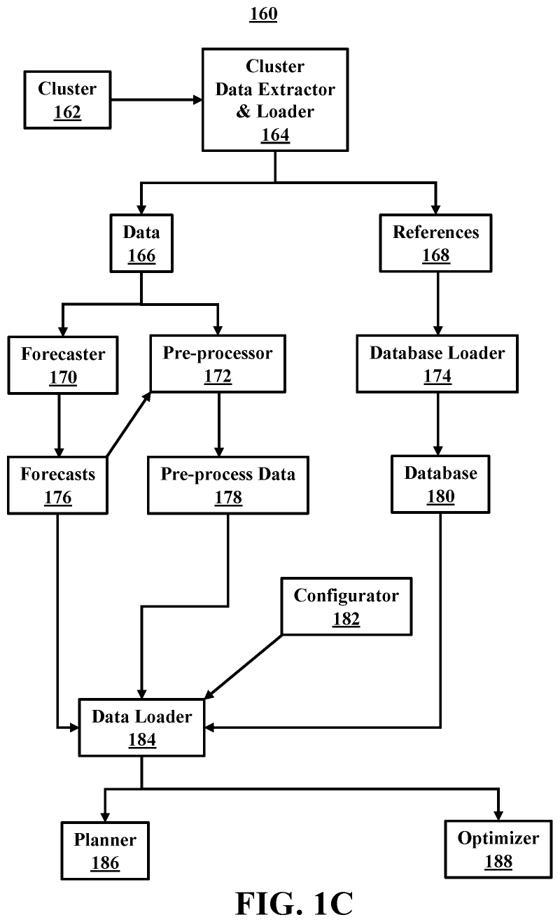

Referring now to FIG. 1A, illustrated is a block diagram of an example system 100 for inventory replenishment planning, in accordance with aspects of the present disclosure. As depicted, the system 100 includes inputs 102A-N, optional historical data 104, geographical clusters 106 (the granularity of the e-commerce demand, clustered on the premise of similar shipping costs), a forecaster 108, an optimizer 110, a planner 112, an explainer 114, a user interface 116, and a comparer 118.

In some embodiments, the inputs 102A-N may include, but are not limited to, internal/external factors (e.g., customer shopping habits, firm revenue, etc.), historical inventory, transaction log(s) (TLOG), an orderline, a stock-keeping unit(s) (SKU), or sometimes referred to herein as a articles), a network, a current inventory, purchase orders, fulfillment cost(s), logistics cost(s), replenishment configurations, business constraints, planned service levels (SLAs), transfer network with lead times, etc.

In some embodiments, as depicted, inputs 102A-C may be used as inputs for the clusters 106 (e.g., shipping cost clusters) and the forecaster 108 (e.g., demand forecasting model for products). In some embodiments, the inputs 102A-C may be the internal/external factors, the historical inventory, the TLOG, the order line, the SKU, and/or the network.

In some embodiments, as depicted, inputs 102C-N may be used as inputs for the optimizer 110 (e.g., optimization model that finds optimal inventory replenishment). In some embodiments, the inputs 102C-N may be the order line, the SKU, the network, the current inventory, the purchase orders, the fulfillment cost(s), the logistics cost(s), the replenishment configurations, the business constraints, planned service levels (SLAs), and/or the transfer network with lead times.

In some embodiments, the cluster 106 may communicate its output (e.g., zipcode clusters and node to cluster shipping cost[s]) to the forecaster 108. In some embodiments, the forecaster 108 may communicate its output (e.g., predictions for replenishment of inventory) with the optimizer 110 as a weekly uncensored demand forecast (e.g., sku-node, sku-zip3 cluster, etc.) with associated prices. In some embodiments, in addition, or simultaneously, to communicating with the optimizer 110, the forecaster 108 may communicate with the planner 112 as daily virtual sku-node sales for a given TLOG.

In some embodiments, the optimizer 110 may communicate its output (e.g., optimal inventory replenishment model) to the planner 112. In some embodiments, the optional historical data 104 (e.g., historical replenishments) may be relayed to the planner 112 as an as-is replenishment (e.g., historically an X amount of inventory is needed for replenishment as-is [for example, traditionally, 5 units are needed to replenish a certain item throughout a majority of the year], etc. for the purpose of creating historical KPI baselines).

In some embodiments, the planner 112 may be a what-if simulator that simulates one or more possibilities of inventory replenishment (e.g., if only 3 units are ordered for replenishment for an item, the inventory for the item will be too much, if 8 units are ordered for replenishment of another item, the inventory for the other item will be too little, etc.). In some embodiments (not depicted), the planner 112 may include a retail simulator (e.g., that simulates shopping habits of users on certain days/times/etc., etc.).

In some embodiments, the planner 112 may communicate its output (e.g., simulations, plans based on simulations, etc.) to the comparer 118, where the comparer 118 compares (simulations of) KPIs of different replenishment schedules. In some embodiments, the comparer communicates with the user interface 116 and the user interface 116 displays the different replenishment schedules to a user.

In some embodiments, the planner 112 may simultaneously communicate with the user interface 116 and automatically adjust control parameters based on user input associated with the display of the different replenishment schedules (e.g., the user may control the comparisons and/or select which replenishment they desire [for example, only order 1 unit of X item, instead of 2 units, and 5 units of Y item instead of 2 units, etc.], etc.).

In some embodiments, the optimizer 110 may communicate its output to the explainer 114. In some embodiments, the explainer 114 may explain the decisions of the optimizer (e.g., 1 unit is needed instead of 3 units for item X because it is less likely to sell during a holiday time period, etc.). In some embodiments, the output of the explainer 114 may be relayed to the user via the user interface 116.

It is noted that, in some embodiments, the forecaster 108 may utilize AI time series models to predict uncensored demand by market segment at each supply chain node and online zip. Further, the optimizer 110 may find the optimal amount of product (e.g., a specific item) to position in each node based on demand prediction to maximize overall benefits (e.g., monetary, etc.) considering all omnichannel costs. Additionally, the planner 112 may enable users to run what-if simulations to understand trade-offs of different positioning policies and business process considerations.

As an in-depth example for the system 100 (sometimes referred to as a “SpotOn” system), which may be an add-on for an existing firm's system, there are three main components that are focused on. First, the forecaster 108 that uses time series and deep learning models to predict demand for each SKU-node. Second, the optimizer 110 that uses the forecast/prediction, business objectives, and constraints to find the best amount of inventory to place in each distribution center (DC). For example, the forecaster 108 look at what the uncensored SKU level demand for walk-in, online, and BOPIS at the lowest level is (e.g., node, zipcode, etc.).

Further, the optimizer 110 may provide/set an optimum inventory point at an SKU-node. In such an embodiment, the optimizer 110 maximizes overall benefits considering omnichannel costs, such as: stockout cost, holding costs, markdown costs, incoming and outgoing logistics costs, fulfillment and handling costs driven from network topology while incorporating operational constraints, etc. Additionally, in such an embodiment, the optimizer 110 may incorporate dependencies across items, operational and other node performance\balance, disruption risks and operational uncertainty, inventory inaccuracy, etc. For example, rather than looking at individual nodes, the optimizer 110 will look at omnichannel fulfillment and the system 100 will collaborate together with all components to fulfill inventory demand and determine where to put the inventory.

Thirdly, the planner 112 may allow users to run different simulations in order to understand the impacts of changing their replenishment policies. For example, the planner 112 may simulate three customer demand behaviors day by day (running for 3-4 months). The planner 112 may replay the past or future (as simulations): “Had I placed X units of SKU: ABC at node 123 . . . how does this impact KPIs? How much lost sales incurred? Revenue made? Items shipped? etc.?”

In some embodiments, the replay may be a replay of the past that is combining historical transaction data together with the virtual lost sales (which are unobserved). The virtual lost sales may alternatively be generated from uncensored demand forecast imputations within the historical data. In some embodiments, the replay may be the future, where the distributional/uncertain forecasts can be used to generate Monte Carlo demand sample paths. The KPIs in the latter case can be averaged over all the sample paths. A variety of other statistical estimates of the KPIs, such as the standard deviation, the 90% confidence interval, can be obtained.

It is noted that although the example presented above details one level of granularity, e.g., X units of SKU, it is not limited to such one level of granularity. Moreover, often times, a strategy/method is chosen and is replicated for a SKU (or all selected SKUs) over and over again for a select period of time (e.g., 3 months, etc.). For example, a strategy can be if a forecast is 10 units and a retailer has 7 units, then the retailer will place 3 units of order. But now if the forecast is uncertain, there is a different strategy (e.g., place an additional safety stock, say 2 units, beyond 3 units, due to uncertainty, etc.). Similarly what if all locations and all channels have an uncertain demand and the inventory in the warehouse (when shipped from there) is limited; the strategy would be different (e.g., provide most units to most popular retail front, etc.). Or, what if, as in the online setting, these demands can be pooled, i.e., the uncertainty drops in aggregate, then the strategy will also be different (e.g., units provided to warehouses first, etc.).

Referring now to FIG. 1B, illustrated is a flowchart of example processes 120 and 130 for a planner (e.g., what-if planner) of inventory replenishment planning, in accordance with aspects of the present disclosure. In some embodiments, the planner described in regard to FIG. 1B may be the same as, or substantially similar to, the planner 112 of FIG. 1A.

In some embodiments, the planner of FIG. 1B by ways of the processes 120 and 130 may enable users to run retail chain level what-ifs (e.g., simulations, predictions, etc.) for different business use cases, configurations, replenishment methods, fulfillment and returns policies, and more importantly, business processes to evaluate their impact on various KPIs. It is noted that in one embodiment, demand is implemented using actual sales history and predicted lost sales from uncensored demand estimation(s) and in another one, the demand is Monte Carlo sample path generated from the forecasts.

In some embodiments, as depicted, the process 120 may be an initialization process by the planner and includes the planner loading initial inventory 122 (e.g., levels, amounts, data, etc.). The planner may further load daily forecasts 124 (e.g., daily walk-in sales forecasts, BOPUS forecasts, virtual sales forecasts, etc.). The planner may further load a rate (e.g., price) calendar 126.

In some embodiments after initialization/process 120, the planner may perform process 130, which may be a daily process. In some embodiments, the planner may utilize the process 120 in order to perform the process 130. As depicted, the process 130 may include the planner updating inventory with incoming reloads 132 (e.g., update inventory with incoming returns, receipts, replenishments, transfers, etc.).

The planner may further update inventory with walk-in point of sale (POS) data 134. The planner may further process Ecommerce (Ecom) sales orders 136. In some embodiments, while processing the Ecom sales orders 136, the planner may also update inventory after each order made from the Ecom sales.

In some embodiments, the planner may further update inventory with virtual walk-in POS data 138. The planner may further process Ecom return orders 140. In some embodiments, while processing the Ecom return orders 140, the planner may also update “incoming” inventory (e.g., returns coming back, replenishments not in yet, etc.). In some embodiments, the planner may further provide periodic replenishment 142 (or transfers), such as for or within the next seven days.

In some embodiments, as depicted, while/when processing Ecom sales orders 136, the planner may process the Ecom sales orders 136 via a fulfillment engine 144. In some embodiments, fulfillment engine 144 may be, or include, “greedy fulfillment,” which may include a prioritization of fulfillment locations. For instance, prioritize: complete shipments for firms/entities that need inventory, distribution centers, excess inventory stores within a proximity, limited inventory stores within a proximity, etc. In some other embodiments, the fulfillment engine 144, can be a fulfillment optimizer that minimizes total fulfillment costs which includes shipping costs due to split shipments in an e-com order.

In some embodiments, as depicted, while/when processing Ecom return orders 140, the planner may provide/generate returns optimization via a return engine 146. In some embodiments, returns engine 146 may include/utilize, returns of purchase orders, a seven days ahead distribution center return, etc.

In some embodiments, as depicted, while/when providing periodic replenishment 142, the planner may utilize a replenishment engine 148. In some embodiments, the replenishment engine 148 may be, or include, optimization based on a rules (e.g., rule-based) provided by a user or firm/entity, or SpotOn a omnichannel replenishment optimizer that minimizes total cost as provided by rules included in AI/ML or software presented in the present disclosure.

In some embodiments, fulfillment engine 144 and replenishment engine 148 may interact to provide a forecasting and fulfillment synchronization (e.g., forecast that X items are needed at distribution warehouse Y, Z items are needed at entity A, etc. and synchronizing each channel associated with the locations and their item replenishment forecast). In such an embodiment, synchronization allows for each location in a supply chain to not be over and/or underfilled at any given time (e.g., brick and mortar location knows that distribution center has an amount of inventory, and the brick and mortar location knows their amount of inventory, etc.).

Before turning to FIG. 1C, it may be beneficial to describe the configurations of the planner disclosed throughout this disclosure. For a replenishment business case and a chosen set of scenarios for what-ifs, the planner may provide an impact on a variety of KPIs for a chosen set of SKUs in an omnichannel environment over a retail network with transaction level operations with an automatic synchronization of various configurations (e.g., forecasts, returns, etc.) across various components.

It is noted that the business use cases may involve: (1) in-season replenishment within a retail network; (2) distribution of bulk purchase order inventory across retail nodes; and/or (3) deciding purchase orders from suppliers and/or a combination of the above at different time cadences (e.g., (1) weekly and (2) or (3) every 2-6 months for fashion items like jackets, etc.).

It is further noted that for the chosen set of SKUs and the retail network, that possible configurations over which impact (on KPIs) can be evaluated are: types of SKUs; the retail network (e.g., configured to understand the impact of open or closing certain locations for certain SKUs); periodicity of replenishment, time period (specific period) of impact (e.g., holidays, full-year, etc.); initial inventory and the strategy for purchase orders and transfers (e.g., given or to be optimized); geo-clustering for Ecom demand forecast; forecasting: the algorithmic method adopted, its outputs (point\distributional, censored or uncensored, predictions at multiple levels of the hierarchy in addition to the most granular level, etc.); optimization: historical replenishment, single channel and sequential methods, multi-channel methods that ignore fulfillment, SpotOn replenishment optimizer that coordinates with downstream fulfillment method (input to this planner); and/or business process changes: capacity constraints, logistics cost variations, lead time variations, marketing or holiday events, etc.

In some embodiments, as discussed above, there are key differences between currently used as-is methods in regard to supply chain and inventory replenishment. For instance, current methods/techniques look at forecast metrics, optimization metrics, and the individual best method, unlike the overall best method.

What-if methods available in the market are spreadsheet-based estimations and not as granular at a transaction level as is the planner disclosed herein. Further, the planner disclosed herein is different from current fulfillment, and/or return, planners in that: the input data, configurations, and the what-if questions are different (e.g., impact of fulfillment method or returns method for a given replenishment, now it is impact of replenishment method and hence input, configurations, modules related to that, for example, uncensored demand forecasting, clustering, replenishment decision system); automatic synchronization of forecasts and returns between replenishment and downstream processes are managed, which is not done currently; and the output KPIs are different (e.g., balance ratio, lost sales quantity, etc.).

Additionally, the disclosed planner uses a combination of transaction level observed sales as well as transaction level unobserved lost sales data that can be run fast enough to efficiently compute/simulate various what-ifs/predictions. Further, the planner can be configured to use various demand forecasts for the different engine/optimization (e.g., 144, 146, 148) configurations.

In some embodiments, the various what-ifs/predictions computed/simulated by the planner may include or be computed/simulated based on Monte Carlo sample paths. The planner itself can be parallelized/distributed across the different sample paths and within each path, if there are operations per article (e.g., if the replenishment is at the article level, ignoring cross-item interactions), can be implemented in a distributed fashion.

It is noted that the solution disclosed herein (e.g., planner) via a Monte Carlo sampling approach to simulation may be using learned distribution of demand (which is a random variable) to simulate multiple possible inventory trajectories under given network configurations (e.g., given starting inventory position, replenishment configuration, and replenishment decision process) to characterize the distribution of possible results/outcomes. In this way there can be a distribution of KPIs corresponding to different trajectories. For example, one could run 100 different simulations for the same, say 1 month in a season, and each one simulation results in a different outcome (e.g., how inventory is consumed and replenished throughout the month) due to different random sampled demand. Each outcome may result in a different KPI score for each KPI. From this once may essentially have a distribution for each KPI and one could say, under the specific configuration, what is the expected KPI (e.g., equal to the mean of the KPI values for each simulation run), what is the standard deviation with each simulation run, what are the max. and min. KPI values, what are the likely high and low values (e.g., 95th percentile and 5th percentile), etc.

Referring now to FIG. 1C, illustrated is a block diagram of an example pre-processing system 160 for inventory replenishment planning, in accordance with aspects of the present disclosure. In some embodiments, the pre-processing system 160 may be utilized in conjunction with, or be a part of, the system 100 of FIG. 1A, and/or help the planner of FIG. 1B fulfill processes 120 and 130.

In some embodiments, as depicted, the pre-processing system 160 includes a cluster 162 (e.g., sterling cluster) that is in communication with a cluster data extractor and loader 164. The cluster data extractor and loader 164 then generates data 166 and references 168. In some embodiments, data 166 may include: inventory, order lines, replenishments, TLOGs, SKUs, etc. In some embodiments, the references 168 may include: “Node Properties,” “Transit matrix,” “Rate Card,” “Carrier Mode Factor,” “Node Carrier Mode Availability,” “Product,” “Transfer Network with lead times”, “Business constraints” (such as the min\max quantity at a node based on storage constraints, pre-pack sizes, minimum replenishment quantities), “Fulfillment service levels” (e.g., 95% of the walkin demand needs to be met, 90% of my online customers should receive their shipments in 2 days) etc.

In some embodiments, the data 166 is communicated with a forecaster 170 and a pre-processor 172. In some embodiments, the forecaster 170 generates forecasts 176, which may include: a walk-in forecast (e.g., in-store shopping), Ecom forecast, Ecom and walk-in price estimate (e.g., in-store price time series, online price time series, etc.), virtual POS, etc. In some embodiments, the forecasts 176 are communicated with the pre-processor 172 and a data loader 184.

In some embodiments, the pre-processor generates pre-process data 178, which may include: inventory, SKUs, SKU node periodic demand, zip node distance, SKU node eligibility, Ecom sales, walk-in sales, crystal ball information (e.g., referring to the instances when forecasts are perfect, meaning the realizations are exactly what was predicted. These can be obtained in hindsight and are non-anticipatory in nature. However they can be used to get a perfect KPI obtained with these perfect forecasts), etc. In some embodiments, the pre-process data 178 is communicated with the data loader 184.

In some embodiments, the references 168 are communicated with a database loader 178 (e.g., MongoDB® loader). The database loader 174 then loads the database 180 (e.g., MongoDB®). In some embodiments, the database 180 is communicated with the data loader 184. In some embodiments, a configurator 182 communicates configurations (e.g., rules) with the data loader 184. In some embodiments, all inputs (e.g., forecasts 176, pre-process data 178, configurator 182, and database 180) to the data loader 184 are utilized by the data loader 184 and loaded data is communicated with a planner 186 and an optimizer 188. It is noted that in some embodiments, one or more components of the pre-processing system 160 may be the same as, or substantially similar to, the components of FIG. 1A, or components utilized by the processes 120 and/or 130 of FIG. 1B.

In some embodiments, which are not depicted for the sake of brevity, either the system 100 of FIG. 1A and/or the pre-processing system 160 of FIG. 1C may include one or more of the components listed below, for instance:

A geo-clustering component for Clustering zip3 based on shipping cost vectors to improve forecasting; a forecasting component (e.g., in some instances forecaster 108 of FIG. 1A or 170 of FIG. 1C) for forecasting of uncensored demand (e.g., point with uncertainty) at SKU-node, SKU-zone (and higher location hierarchies) and associated prices (e.g., with any imputations needed); an historical data extraction component that uses retailer big data to prepare various data sets to be loaded in a planner environment; a fulfillment solver component that mimics logic of complete shipments, distribution center first, density and demand for outbound fulfillment prioritized by nodes that are near nodes and have unconstrained inventory (e.g., measured by weeks of supply); an Ecom order orchestrator that manages and sends Ecom sales to appropriate solvers; a shipping cost estimator that computes shipping cost for fulfillment and returns with rate cards, weights, transit data, carrier data, SLAs, etc.;

An inventory manage that manages inventory at item-node level as on-hand, incoming and on-hand return; a walk-in sales and returns manager that manages the fulfillment of (1) observed walk-in sales plus (+) (2) unobserved walk-in virtual sales and (3) less returns to predesignated distribution center nodes; a replenishment orchestrator that periodically calls a replenishment module in a correct configuration (e.g., supplier/port to the retailer or the distribution center to stores), with the appropriate inputs; a replenishment optimizer that optimizes the replenishment from node-to-node (e.g., usually distribution center to store, but trans-shipment is included) or supplier/port to node;

A replenishment as-is logic component that computes periodic replenishment to stores from retail distribution centers using retailer provided logic or using historical replenishment files; a transfer manager that computes rule-based periodic transfers across eligible distribution center lanes using retailer provided approximated logic; a capacity manager that keeps track of capacity consumption at each node (e.g., how many goods to satisfy customers at each location, etc.); a KPI computation engine that uses simulation log data to compute aggregate KPIs; and a what-if orchestrator engine that uses UI and back-end structure to enable management of various what-if scenarios.

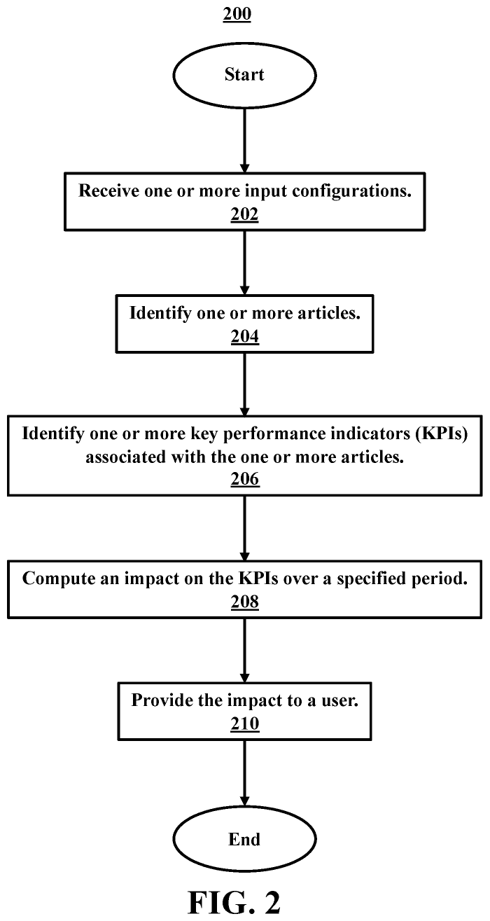

Before turning to FIG. 2, it is noted that any or all of the planners discussed in regard to FIGS. 1A-C may represent a full-scale operational model representation of supply chain in all aspects (e.g., modules for forecast, inventory levels, replenishment, fulfilment, etc.) associated with specific inventory, along with high-dimensional actual (and/or simulated) time series data associated with all modules of the supply over a long time horizon (e.g. months). Any of the embodiments for the modules in the disclosed planner(s) can be added as plug-ins (e.g., if a retailer is entirely Ecom, then walk-in analysis can be dismissed, vice-a-versa, etc.) in combination, or separately, to the planner(s) to perform complex what-if analyses and track KPIs.

Referring now to FIG. 2, illustrated is a flowchart of an example method 200 for inventory replenishment planning, in accordance with aspects of the present disclosure. In some embodiments, the method 200 may be performed by a processor (e.g., of system 100 of FIG. 1A, of pre-processing system 160, etc.) and/or the SpotOn planner discussed throughout this disclosure. In some embodiments, the processor may be in an omnichannel environment that is over a specific (e.g., retail) network with transaction level operations.

In some embodiments, the method 200 begins at operation 202, where the processor receives one or more input configurations (e.g., choices that at least include the what-ifs around a chosen periodicity of replenishment, algorithms, a granularity and types of omnichannel forecasting outputs including lost-sales realizations, a difference of replenishment optimization that can consume forecasts as inputs, types of network shipments [distribution center to store, store to store, supplier node to distribution center and\or store nodes], changes in business processes such as type of fulfillment method\returns method, marketing events, logistics, transportation and fulfillment costs, etc.).

In some embodiments, the method 200 proceeds to operation 204, where the processor identifies, based on the one or more configurations, one or more articles (e.g., SKUs). In some embodiments, the method 200 proceeds to operation 206, where the processor identifies one or more KPIs associated with the one or more articles.

In some embodiments, the method 200 proceeds to operation 208, where the processor computes, based on an uncensored demand trajectory, an impact on the KPIs over a specified period (e.g., a holiday period, a seasonal period, a future time, etc.) in the omnichannel environment. In some embodiments, the demand trajectory can be generated from an historical actual demand realized together with imputed lost sales estimate (e.g., virtual sales estimate), or from a Monte Carlo sample from an uncensored demand forecast (e.g., where uncensored refers to the fact that the forecast accounts also for unobserved lost sales).

In some embodiments, the method 200 proceeds to operation 210, where the processor provides the impact to a user. In some embodiments, the method 200 may end.

In some embodiments, discussed below, there are one or more operations of the method 200 not depicted for the sake of brevity and which are discussed throughout this disclosure. Accordingly, in some embodiments, providing the impact to the user may include the processor generating a demand forecast used for replenishment of specific inventory. The specific inventory may be associated with the one or more articles.

In some embodiments, the generating the demand forecast used for replenishment of specific inventory may include the processor analyzing a fulfillment segment at a granular level and an aggregated level and generating an uncertain forecast as the demand forecast. The uncertain forecast may include a full distribution or prediction intervals that are used for replenishment/distribution.

In some embodiments, the processor may optimize replenishment, where optimizing replenishment may include the processor identifying one or more rules from a controlling entity and consuming an output of the demand forecast.

In some embodiments, the processor may utilize virtual sales estimates during the specified period. These are unobserved lost sales, which are imputed from the historical sales data. If the evaluation period is in the history, using these forecasts are imperative as they then show the possible gain that would have been achieved, if the inventory was present. In some embodiments, the virtual sales estimates may be associated with a what-if simulation/model or may be a virtualization of actual sales performed across all channels (e.g., Ecom, in stores, etc.).

In some embodiments, the processor may update inventory with incoming reloads. The processor may update inventory with walk-in point of sale data. The processor may process Ecommerce sales orders (as associated with the inventory). The processor may update the inventory with virtual walk-in point of sale data. The processor may process Ecommerce return orders (as associated with the inventory). The processor may replenish, periodically, the inventory.

In some embodiments, the processor may synchronize, automatically, one or more pluggable components in the omnichannel environment as based on the one or more input configurations (e.g., synchronizing rules across all channels as based on user input, etc.). For example, 100 units of an item are forecasted for sale, but 80 units are forecasted for sale on-line versus in-store, accordingly the channels associated with on-line, and in-store are synchronized such that each channel identifies that a total of 100 units are forecasted for sale, but 80 are to be sent to a distribution center for on-line sales and 20 are to be sent to a brick and mortar store.

In some embodiments, it is noted that, the method 200, the system 100, and/or the (SpotOn) planner discussed throughout this disclosure may enable a user to run what-if simulations to understand trade-offs of different positioning policies and business process considerations (e.g., configurations). The following KPIs/KPI outputs discussed below may be estimated by SKU-date (e.g., sometimes by date for a group of SKUs) being analyzed and may be aggregated together, in regard to the what-if simulations:

Carbon\emission costs: with the disclosed planner, such net carbon costs due to transportation, fulfillment and storage can also be computed and reported; Total Profit Margin: defined as the sum of profit across all channels less the fulfillment, logistics and labor costs (alternatively supply chain cost ratio to net sales); Sales Made\Lost by Channel: meaning a number of units sold\lost (e.g., related KPIs—achieved service level or fill rate);

Profit Made\Lost by Channel: defined as (channel price minus (—) landed cost of item) multiplied by (*) number of units sold, aka, demand won\lost. Different nodes/stores have different margins, as well as BOPIS/walk-in sale margins; Fulfillment\Shipping Costs: meaning fulfillment package costs (e.g., including ship-from-DC and ship from store);

Emission, Labor, Logistics Costs: including emissions, labor, processing, holding, transportation and other costs; On-time delivery fraction: meaning a fraction of eligible orders delivered in delivery time SLA input provided; and Inventory Days Lasting: meaning average days the inventory is held before a sale (e.g., measuring operational and financial efficiency). Specifically, it is horizon (e.g., investment time horizon) multiplied by (*) average inventory value/cost of goods sold.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

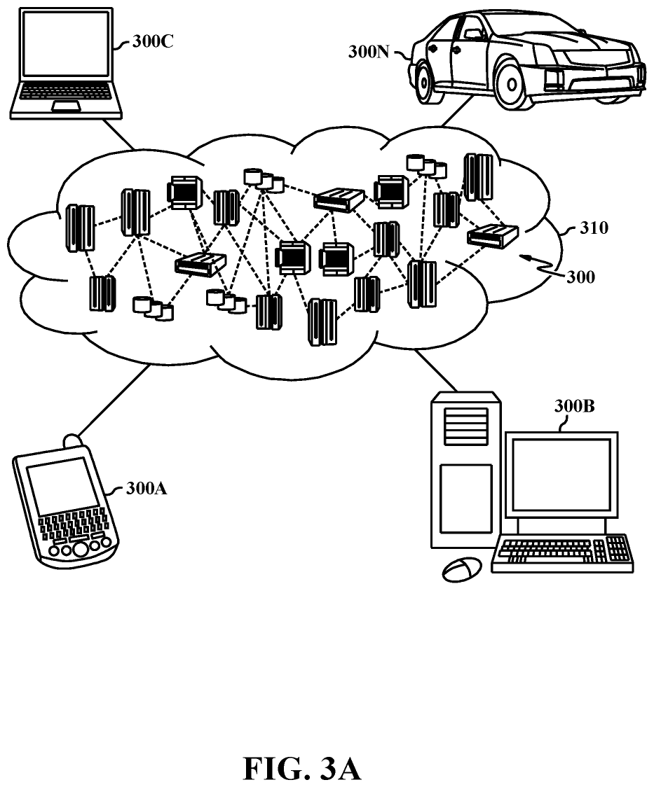

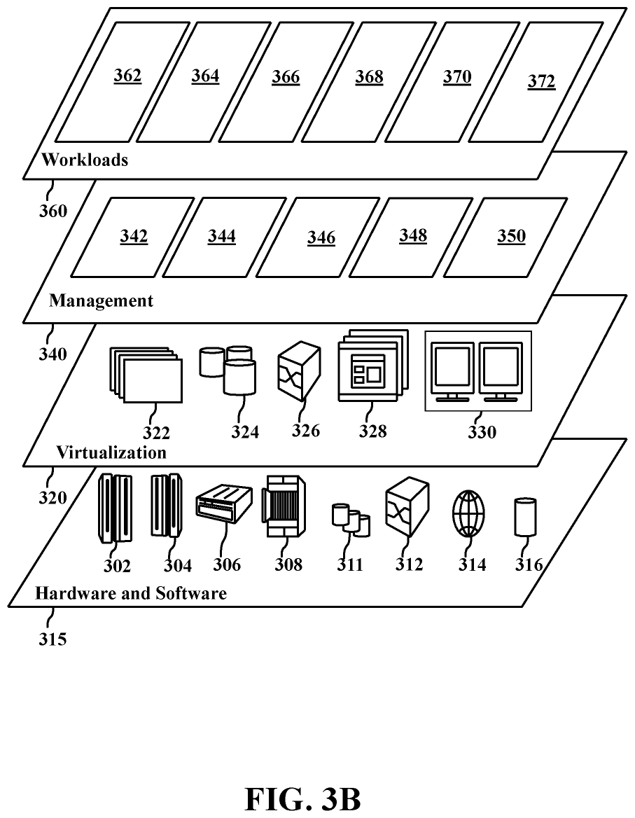

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and inventory replenishment planning 372.

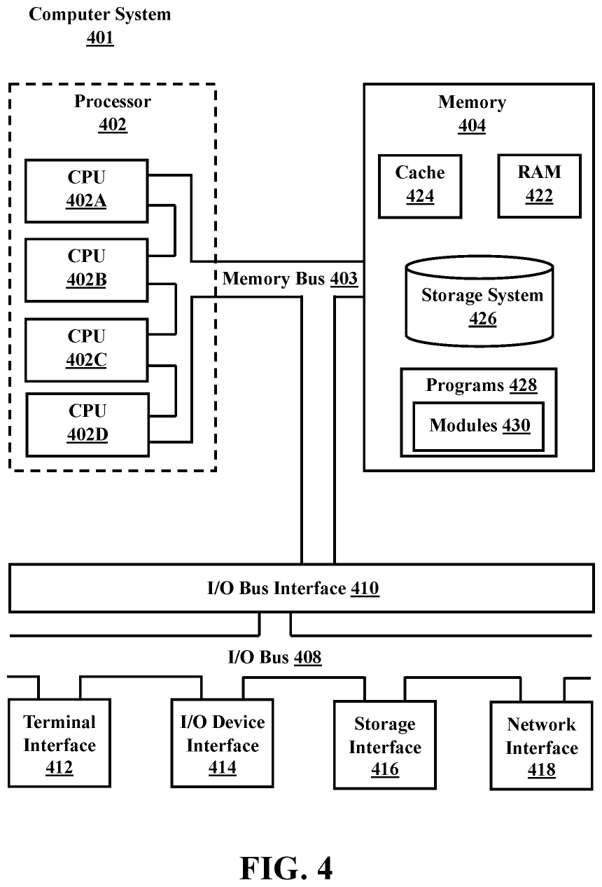

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A system for inventory replenishment planning, the system comprising:
a memory; and
a processor in an omnichannel environment, over a specific network with transaction level operations, and in communication with the memory, the processor being configured to perform operations comprising:
receiving one or more input configurations;
identifying, based on the one or more input configurations, one or more articles;
identifying one or more key performance indicators (KPIs) associated with the one or more articles;
computing, based on an uncensored demand trajectory, an impact on the KPIs over a specified period in the omnichannel environment; and
providing the impact to a user.

2. The system of claim 1, wherein providing the impact to the user includes:
generating a demand forecast used for replenishment of specific inventory, wherein the specific inventory is associated with the one or more articles.

3. The system of claim 2, wherein generating the demand forecast used for replenishment of the specific inventory includes:
analyzing a fulfillment segment at a granular level (SKU-location-fulfillment segment level) and an aggregated level; and
generating an uncertain forecast as the demand forecast, wherein the uncertain forecast includes a full distribution or prediction intervals that are used for replenishment.

4. The system of claim 2, wherein the processor is further configured to perform operations comprising:
optimizing replenishment, wherein optimizing replenishment includes:
identifying one or more rules from a controlling entity, and
consuming an output of the demand forecast.

5. The system of claim 1, wherein the processor is further configured to perform operations comprising:
utilizing virtual sales estimates during the specified period.

6. The system of claim 1, wherein the processor is further configured to perform operations comprising:
updating inventory with incoming reloads;
updating inventory with walk-in point of sale data;
processing Ecommerce sales orders;
updating the inventory with virtual walk-in point of sale data;
processing Ecommerce return orders; and
replenishing, periodically, the inventory.

7. The system of claim 1, wherein the processor is further configured to perform operations comprising:
synchronizing, automatically, one or more pluggable components in the omnichannel environment as based on the one or more input configurations.

8. A computer-implemented method for inventory replenishment planning, the method comprising:
receiving, by a processor in an omnichannel environment, over a specific network with transaction level operations, one or more input configurations;
identifying, based on the one or more input configurations, one or more articles;
identifying one or more key performance indicators (KPIs) associated with the one or more articles;
computing, based on an uncensored demand trajectory, an impact on the KPIs over a specified period in the omnichannel environment; and
providing the impact to a user.

9. The computer-implemented method of claim 8, wherein providing the impact to the user includes:
generating a demand forecast used for replenishment of specific inventory, wherein the specific inventory is associated with the one or more articles.

10. The computer-implemented method of claim 9, wherein generating the demand forecast used for replenishment of the specific inventory includes:
analyzing a fulfillment segment at a granular level (SKU-location-fulfillment segment level) and an aggregated level; and
generating an uncertain forecast as the demand forecast, wherein the uncertain forecast includes a full distribution or prediction intervals that are used for replenishment.

11. The computer-implemented method of claim 9, further comprising:
optimizing replenishment, wherein optimizing replenishment includes:
identifying one or more rules from a controlling entity, and
consuming an output of the demand forecast.

12. The computer-implemented method of claim 8, further comprising:
utilizing virtual sales estimates during the specified period.

13. The computer-implemented method of claim 8, further comprising:
updating inventory with incoming reloads;
updating inventory with walk-in point of sale data;
processing Ecommerce sales orders;
updating the inventory with virtual walk-in point of sale data;
processing Ecommerce return orders; and
replenishing, periodically, the inventory.

14. The computer-implemented method of claim 8, further comprising:
synchronizing, automatically, one or more pluggable components in the omnichannel environment as based on the one or more input configurations.

15. A computer program product for inventory replenishment planning comprising a computer readable storage medium having program instructions embodied therewith, the program instructions executable by a processor in an omnichannel environment, over a specific network with transaction level operations, to cause the processor to perform operations, the operations comprising:
receiving one or more input configurations;
identifying, based on the one or more input configurations, one or more articles;
identifying one or more key performance indicators (KPIs) associated with the one or more articles;
computing, based on an uncensored demand trajectory, an impact on the KPIs over a specified period in the omnichannel environment; and
providing the impact to a user.

16. The computer program product of claim 15, wherein providing the impact to the user includes:
generating a demand forecast used for replenishment of specific inventory, wherein the specific inventory is associated with the one or more articles.

17. The computer program product of claim 16, wherein generating the demand forecast used for replenishment of the specific inventory includes:
analyzing a fulfillment segment at a granular level (SKU-location-fulfillment segment level) and an aggregated level; and
generating an uncertain forecast as the demand forecast, wherein the uncertain forecast includes a full distribution or prediction intervals that are used for replenishment.

18. The computer program product of claim 16, wherein the processor is further configured to perform operations comprising:
optimizing replenishment, wherein optimizing replenishment includes:
identifying one or more rules from a controlling entity, and
consuming an output of the demand forecast.

19. The computer program product of claim 15, wherein the processor is further configured to perform operations comprising:
utilizing virtual sales estimates during the specified period.

20. The computer program product of claim 15, wherein the processor is further configured to perform operations comprising:
updating inventory with incoming reloads;
updating inventory with walk-in point of sale data;
processing Ecommerce sales orders;
updating the inventory with virtual walk-in point of sale data;
processing Ecommerce return orders; and
replenishing, periodically, the inventory.
